(19) United States
(12) Patent Application Publication
(10) Pub. No.: US 2006/0141308 A1
(43) Pub. Date: Jun. 29, 2006

(54) Apparatus and method for variable conductance temperature control

(76) Inventors: Juan J. Becerra, Altamont, NY (US); Charles M. Carlstrom JR., Saratoga Springs, NY (US); George M. Costantino, Schenectady, NY (US); Robert S. Hirsch, Troy, NY (US); David H. Leach, Albany, NY (US)

Correspondence Address: CESARI AND MCKENNA, LLP, 88 BLACK FALCON AVENUE, BOSTON, MA, 02210, US

(21) Appl. No.: 11/021,971

(22) Filed: Dec. 23, 2004

(51) Int. Cl. H01M 8/04; H01M 8/10; F28F 27/00; G05D 23/00

(52) U.S. Cl. 429/24; 429/30; 429/13; 165/276; 165/287

(57) ABSTRACT

An integrated heat management assembly that is thermally coupled to a component requiring temperature control is provided. The integrated heat management assembly in one embodiment of the invention is a heat switch which includes two opposed surfaces, a first surface being a hot contact which is coupled to the component, and the second surface being a cold contact which is coupled to a heat sink. An actuator which may be a phase changing material, is mechanically coupled to one of the two surfaces such that when the component reaches a threshold temperature, the actuator is triggered to bring the two surfaces into contact. In this manner, the hot surface conducts heat to the cold surface which then delivers heat to the heat sink to thereby lower the temperature of the component. Other embodiments include heat pipes associated with the heat switch in order to further dissipate heat or to divert it to other areas of the component requiring temperature control. Corresponding techniques are provided in accordance with the method of the invention.

### BACKGROUND OF THE INVENTION

1. Field of the Invention

This invention relates generally to thermal management, and more particularly, to thermal management control techniques using variable thermal conductance.

2. Background Information

Fuel cells are devices in which electrochemical reactions are used to generate electricity from fuel and oxygen. A variety of materials may be suited for use as a fuel depending upon the materials chosen for the components of the cell. Organic materials in liquid form, such as methanol are attractive fuel choices due to the high specific energy.

Fuel cell systems may be divided into “reformer-based” systems (i.e., those in which the fuel is processed in some fashion to extract hydrogen from the fuel before the hydrogen is introduced into the fuel cell system) or “direct oxidation” systems in which the fuel is fed directly into the cell without the need for separate internal or external fuel processing. Many currently available fuel cells are reformer-based. However, because fuel processing is complex and generally requires costly components which occupy significant volume, reformer based systems are more suitable for comparatively high power applications.

Direct oxidation fuel cell systems may be better suited for applications in smaller mobile devices (e.g., mobile phones, handheld and laptop computers), as well as for somewhat larger scale applications. In direct oxidation fuel cells of interest here, a carbonaceous liquid fuel (typically methanol or an aqueous methanol solution) is directly introduced to the anode face of a membrane electrode assembly (MEA).

One example of a direct oxidation fuel cell system is the direct methanol fuel cell or DMFC system. In a DMFC system, a mixture comprised of predominantly methanol or methanol and water is used as fuel (the “fuel mixture”), and oxygen, preferably from ambient air, is used as the oxidant. The fundamental reactions are the anodic oxidation of the fuel mixture into CO₂, protons, and electrons; and the cathodic combination of protons, electrons and oxygen into water. The overall reaction may be limited by the failure of either of these reactions to proceed to completion at an acceptable rate, as is discussed further hereinafter.

Typical DMFC systems include a fuel source or reservoir, fluid and effluent management systems, and air management systems, as well as the direct methanol fuel cell (“fuel cell”) itself. The fuel cell typically consists of a housing, hardware for current collection, fuel and air distribution, and a membrane electrode assembly (“MEA”) disposed within the housing.

The electricity generating reactions and the current collection in a direct oxidation fuel cell system take place at and within the MEA. In the fuel oxidation process at the anode, the fuel typically reacts with water and the products are protons, electrons and carbon dioxide. Protons from hydrogen in the fuel and in water molecules involved in the anodic reaction migrate through the proton conducting membrane electrolyte (“PCM”), which is non-conductive to the electrons. The electrons travel through an external circuit which contains the load, and are united with the protons and oxygen molecules in the cathodic reaction. The electronic current through the load provides the electric power from the fuel cell.

A typical MEA includes an anode catalyst layer and a cathode catalyst layer sandwiching a centrally disposed PCM. One example of a commercially available PCM is NAFION® (NAFION® is a registered trademark of E.I. Dupont de Nemours and Company), a cation exchange membrane based on polyperflourosulfonic acid, in a variety of thicknesses and equivalent weights. The PCM is typically coated on each face with an electrocatalyst such as platinum, or platinum/ruthenium mixtures or alloy particles. A PCM that is optimal for fuel cell applications possesses a good protonic conductivity and is well-hydrated. On either face of the catalyst coated PCM, the MEA further typically includes a “diffusion layer”. The diffusion layer on the anode side is employed to evenly distribute the liquid or gaseous fuel over the catalyzed anode face of the PCM, while allowing the reaction products, typically gaseous carbon dioxide, to move away from the anode face of the PCM. In the case of the cathode side, a diffusion layer is used to allow a sufficient supply of and a more uniform distribution of gaseous oxygen to the cathode face of the PCM, while minimizing or eliminating the accumulation of liquid, typically water, on the cathode aspect of the PCM. Each of the anode and cathode diffusion layers also assist in the collection and conduction of electric current from the catalyzed PCM to the current collector.

Direct oxidation fuel cell systems for portable electronic devices ideally are as small as possible for a given electrical power and energy requirement. The power output is governed by the rates of the reactions that occur at the anode and the cathode of the is fuel cell operated at a given cell voltage. More specifically, the anode process in direct methanol fuel cells, which use acid electrolyte membranes including polyperflourosulfonic acid and other polymeric electrolytes, involves a reaction of one molecule of methanol with one molecule of water. In this process, water molecules are consumed to complete the oxidation of methanol to a final CO₂ product in a six-electron process, according to the following electrochemical equation:
CH₃OH+H₂O [symbol] CO₂+6H⁺+6e⁻ (1)

Since water is a reactant in this anodic process at a molecular ratio of 1:1 (water:methanol), the supply of water, together with methanol to the anode at an appropriate weight (or volume) ratio is critical for sustaining this process in the cell. In fact, it has been known that the water:methanol molecular ratio in the anode of the DMFC has to significantly exceed the stoichiometric 1:1 ratio suggested by process (1), to guarantee complete anodic oxidation to CO₂, rather than partial oxidation to either formic acid, or formaldehyde, 4e⁻ and 2e⁻ processes, respectively, described by equations (2) and (3) below:
CH₃OH+H₂O [symbol] HCOOH+4H⁺+4e⁻ (2)
CH₃OH [symbol] H₂CO+2H⁺+2e⁻ (3)

Equations (2) and (3) are partial anodic oxidation processes that are not desirable and which might occur if the ratio of water to methanol is not sufficient during a steady state operation of the cell. Particularly, as is indicated in process (3), which involves the partial oxidation of methanol, water is not required for this anode process and thus, this process may dominate when the water level in the anode drops below a certain point. The consequence of process (3) domination, is an effective drop in methanol energy content by about 66% compared with consumption of methanol by process (1), which results in a lower cell electrical energy output. In addition, it would lead to the generation of undesirable anode products such as formaldehyde.

Typically, it has been difficult to provide a desirable water/methanol mixture at the anode catalyst in a small, lower volume, compact DMFC technology platform. The conventional approaches to this problem can be divided into two categories:

(A) active systems based on feeding the cell anode with very diluted (2%) methanol solution, pumping excess amount of water at the cell cathode back to cell anode and dosing the re-circulation liquid with neat methanol stored in a reservoir; and

(B) passive systems requiring no pumping, utilizing reservoirs of methanol/water mixtures.

Class A systems, which are active systems that include pumping, can provide, in principle, maintenance of appropriate water level in the anode, but this is accomplished by dosing neat methanol from a fuel delivery cartridge into a recirculation loop. The loop also receives water, which is collected at the cathode and pumped back into the recirculating anode liquid. In this way, an optimized water/methanol anode mix can be maintained. The concentration is usually controlled using a methanol concentration sensor. The advantage of this approach is that a concentrated methanol solution comprised of a molecular fraction of at least 50% methanol, and preferably “neat” methanol (pure methanol) can be carried in the cartridge while a diluted methanol solution carried in the re-circulating loop supplies the required methanol to water ratio at the cell anode. Carrying a high concentration fuel source and recovering water from cell cathode reduces the amount of water needed to be carried in the cartridge and thus reduces the weight and volume of the reservoir and thus, the overall system. The disadvantage is that while neat methanol can be carried in the cartridge, the system suffers from excessive complexity due to the pumping and recirculation components as well as the concentration sensor, which can result in significant parasitic power losses and increases in the weight and volume of the power system. This can be particularly severe when the power system is used as a small scale power source.

The class B systems, comprising passive systems, have the advantage of system simplicity achieved by eliminating water recovering, pumping and recirculating devices by using a design that carries a mixture of water and methanol in the fuel reservoir. This type of system can be substantially, or even completely passive, as long as the rate of water loss through the cathode is adjusted by the water carried “on board” the fuel cell system, typically within the fuel reservoir. The problem with this approach is that it requires that a significant amount of water which has no intrinsic energy content, be carried in the fuel reservoir or cartridge.

A fuel cell system that adapts the best features of both the Class A and Class B systems, without the disadvantages of these two known systems, which is most advantageous for portable power applications, has been described in commonly owned U.S. patent application Ser. No. 10/078,601 filed on Feb. 19, 2002 by Ren et al., and U.S. patent application Ser. No. 10/413,983, filed on Apr. 15, 2003, by Ren et al., both of which are incorporated herein by reference.

In both types of fuel cells, whether water is provided from an external source, or water is generated internally at the cathode and delivered across the membrane, the water balance and the distribution of water throughout the cell must be managed carefully. In the water push back systems, there are several competing considerations to be taken into account. The fundamental challenge is to generate a sufficient flow of cathodically generated water, from the cathode to the anode to provide for the complete oxidation of methanol as per process (1). To do so requires that a portion of the cathodically generated water be pushed back to the anode and have any excess water released as water vapor from the cathode aspect of the fuel cell. In turn, this means that a balance between passive, evaporative loss of water from the cathode and the confinement and controlled distribution of water within the cell must be achieved.

Achieving the correct water balance is importance because hydration of the fuel cell is critical for stable performance of the fuel cell. The fuel cell output power is fundamentally dependent upon the amount of water contained therein, because the protonically conductive membrane needs to be well hydrated in order to work properly, and water is also needed for the anode reaction. If the fuel cell is too dry there could be a power decline and a decline in efficiency. Similarly, if too much water is generated in the fuel cell, and not removed, then the fuel cell can “flood” causing decreased performance and inefficiency in power output.

Water balance in turn, is linked to the temperature and the amount of fuel fed to the fuel cell. The fuel feed rate can be controlled as described in commonly owned U.S. Pat. No. 6,589,679, to Acker et al., for APPARATUS AND METHODS FOR SENSORLESS OPTIMIZATION OF METHANOL CONCENTRATION IN A DIRECT METHANOL FUEL CELL SYSTEM, which is presently incorporated herein by reference.

Heat transfer from the fuel cell to an application device and vice versa are described in commonly owned U.S. patent application Ser. No. 10/213,987 for INTEGRATED HEAT MANAGEMENT OF ELECTRONICS AND FUEL CELL POWER SYSTEM of William P. Acker, filed Aug. 7, 2002, which is presently incorporated herein by reference. However, effective techniques for specifically controlling the internal temperature of a direct oxidation fuel cell to thereby control hydration include, but are not limited to the use of active fans, a dedicated cooling loop that circulates water or fuel, or other active mechanisms that have power requirements and can add to system complexity.

In addition to the fuel cell environment, thermal management and temperature control are also important factors in many other applications, including but not limited to catalytic reactors, systems using one or more heat transfer fluids, systems requiring environmental temperature control, and the like. In such devices, a critical temperature range must be maintained for stable, efficient operation. However, this has not always been possible or practical in prior systems, particularly where size or form factors are constraints.

There remains a need, therefore, for an apparatus and method that provide thermal management and temperature control in a variety of systems. It is thus an object of the present invention to provide such an apparatus and method which controls temperature in a system but which does so using a compact, low power solution.

### SUMMARY OF THE INVENTION

The disadvantages of prior techniques are overcome by the present invention which provides an integrated heat management assembly that is thermally coupled to a component requiring temperature control. An associated method for controlling temperature is also provided.

In a first embodiment of the invention, an integrated heat management device is incorporated into a system that has a component requiring temperature control. The heat management device uses a novel heat switch, which has two opposing surfaces. Heat is substantially conducted from one surface to another when the surfaces are in contact and is substantially blocked when the surfaces are moved apart. In accordance with the invention, the component requiring temperature control is thermally connected to one such surface such that the heat of the component will be transferred thermally to that first surface. The first surface is controllably brought into contact with the second surface which is the cooler surface. The heat is thereby transferred to the cooler surface. The connection of the hot surface to the cold surface is preferably controlled by means of a phase change actuator material, such as paraffin. It should be understood that the invention is not limited to the phase change actuator material, and alternative actuators are well within the scope of the present invention such as bimetallic assemblies, shape memory alloys and the like. The actuator material is coupled to the component in such a manner that heat from the component is passed to the actuator material. The actuator causes a movement in at least one of the two opposing surfaces. Alternatively, an actuator may be used to activate the switch based on sensor readings of ambient conditions such as temperature or humidity.

More specifically, the heat from the component is passed to the paraffin actuator causing a temperature rise, substantially equal to the temperature of the component. If this temperature is at or above the melting point of the paraffin, then the paraffin melts and expands, as determined by the material properties of the paraffin. In accordance with the invention, the actuator material is selected so that it will be actuated when the temperature is higher than that desired for the particular application. At the melt temperature, the paraffin expands and thereby acts on the hot surface to bring it into contact with the cold surface, thereby causing heat to flow away from the component. The component temperature is therefore controlled by the paraffin melting point.

This first embodiment may be employed in a system in which the component requiring temperature is a direct oxidation fuel cell. For purposes of clarity of illustration, the remaining embodiments described refer to a direct oxidation fuel cell, however, though the fuel cell is an illustrative embodiment, the invention is not limited to use with a direct oxidation fuel cell and can instead be readily adapted for use with a variety of components requiring temperature management. Other examples include catalytic reactors, systems using one or more heat transfer fluids and environmentally controlled systems such as closed cabinet temperature-controlled devices.

In yet another embodiment of the invention, the heat switch is used in conjunction with a heat pipe. The heat pipe can be located within or outside of the component requiring temperature management, such as a fuel cell. In accordance with this aspect of the invention, the heat switch triggers the diversion of heat towards the heat pipe and heat is transferred to the heat pipe, which in turn transfers heat to the ambient environment or other heat sink.

Another embodiment has the component requiring temperature management connected to the heat switch via a heat pipe and the heat switch collocated with the heat sink.

In another embodiment there is a heat pipe from the component requiring temperature management the thermally connects to the heated side of the heat switch, and another heat pipe from heat sinking side of the heat switch to the heat sink.

In yet another embodiment, the heat switch is directly connected thermally to both the component requiring temperature management and the heat sink

The heat switch may take heat from one or more locations on the component requiring temperature management. For example, multiple cells in a fuel cell array may be thermally connected to the heat switch.

The materials selected for the integrated heat management assembly of the present invention are chosen based upon the desired operating temperature of the component being regulated. For example, the materials are selected so that the phase change or other action occurs when the temperature of the component is raised to a particular threshold. In the fuel cell application, this threshold is usually selected depending on the water balance desired within the fuel cell. Therefore, the integrated heat management assembly, such as the heat switch, will close at a predetermined temperature in order to thereby control temperature of the fuel cell and in turn control the water balance within the fuel cell. In accordance with another embodiment of the invention, the heat management assembly can be actuated electromechanically under the control of an associated programmable controller which will signal the heat management assembly to start diverting heat away from the component when measured operating characteristics suggest that an undesired temperature increase is occurring.

In accordance with the method of the present invention, fuel cell resistance and other operating characteristics of the fuel cell are measured, and if such measurements indicate an adjustment in hydration is needed, then a heat management assembly can be activated, as needed.

In accordance with yet a further aspect of the invention, one or more heat switches can be extrinsically actuated to control the temperature in a component, such as fuel cell system, as desired, in particular circumstances.

### BRIEF DESCRIPTION OF THE DRAWINGS

The above and further advantages of the invention may be better understood by referring to the following description in conjunction with the accompanying drawings, in which:

FIG. 1A is a schematic block diagram of a component requiring temperature control, coupled to the heat management assembly of the present invention;

FIG. 1B is a schematic block diagram of an illustrative embodiment of the invention in which a fuel cell system incorporates the integrated heat management assembly of the present invention;

FIG. 2A is a schematic illustration of one embodiment of the integrated heat management switch of the present invention, in an open position;

FIG. 2B is a schematic illustration of the system of FIG. 2A with the integrated heat management switch of the present invention illustrated in a closed, heat-transferring position;

FIG. 3A is an isometric illustration of one embodiment of the heat switch fixture of the present invention;

FIG. 3B is a cross-sectional view of the heat switch fixture of the present invention of FIG. 3A taken along lines A-A;

FIG. 4 is a schematic side section of another embodiment of the integrated heat management assembly of the present invention;

FIG. 5A is a graph of heat switch thermal resistance vs. temperature of the hot contact for a test conducted using the device of FIG. 3A;

FIG. 5B is a graph of switch temperature vs. heat input from a test conducted using the device of FIG. 3A;

FIG. 5C is a graph of thermal resistance vs. heat input from a test conducted using the device of FIG. 3A;

FIG. 5D is a graph of actuator temperature vs. ambient temperature from a test conducted using the heat switch of FIG. 3A;

FIG. 6 is a side elevation of an illustrative embodiment of the integrated heat management assembly of the present invention attached to a heat bridge portion of a fuel cell system in accordance with the present invention;

FIG. 7 is a perspective view of the device of FIG. 6;

FIG. 8 is a bottom plan illustration of the embodiment of the invention of FIG. 6 attached to a current collector;

FIG. 9 is a schematic illustration of a heat switch located externally from a component and coupled to the component by a heat pipe;

FIG. 10 is a schematic illustration of a heat switch that is integrated into a component and coupled via a heat pipe to a heat sink;

FIG. 11A is a schematic illustration of another embodiment of the invention in which the heat switch actuator is incorporated into one of the current collectors of a fuel cell, depicted in a non-actuated state;

FIG. 11B is a schematic illustration of the device of FIG. 11A, in an actuated state;

FIG. 12 is a flow chart illustrating a procedure in accordance with one aspect of the method of the present invention; and

FIG. 13 is a schematic illustration of a system in accordance with the invention that includes an extrinsically actuated heat switch for controlling a heat path between a component and one or more portable electronic devices.

### DETAILED DESCRIPTION OF ILLUSTRATIVE EMBODIMENTS OF THE INVENTION

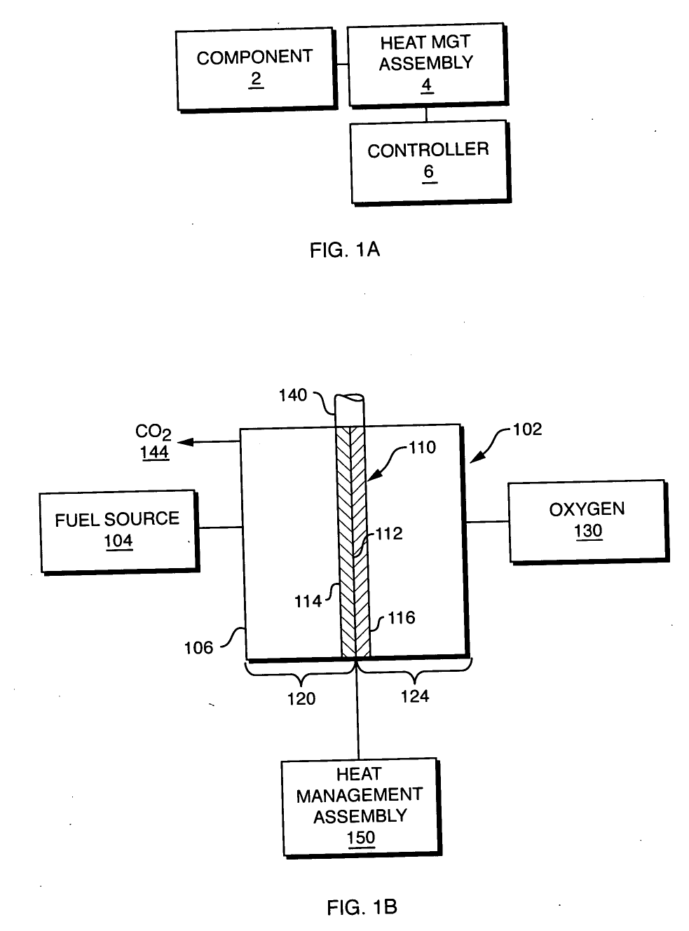

As illustrated schematically in FIG. 1A, a component requiring temperature control 2 is regulated by a heat management assembly 4 in accordance with the present invention. As noted, there are many different devices that require temperature control to which the apparatus and techniques of the present invention may be employed. By way of example, the component 2 may be a direct oxidation fuel cell, including an individual fuel cell, a fuel cell array or a fuel cell stack. Alternatively, the component 2 may be any of a variety of other devices including, but not limited to a catalytic reactor, a system that uses one or more heat transfer fluids, and/or closed cabinet temperature controlled devices. Supervisory control of the heat management assembly 4 may be achieved, if desired, using a programmable controller 6 which may be implement as microcontroller incorporated into the heat management assembly 4 itself or may be implemented into software loaded onto the component 2 electronics. For purposes of complete description and for clarity of illustration, the invention is described with the component being a direct oxidation fuel cell. One example of a direct oxidation fuel cell system 100 is schematically illustrated in FIG. 1B. As set forth herein, fuel cell system 100 includes a direct oxidation fuel cell, which may be a direct methanol fuel cell (DMFC) 102, for example. For purposes of illustration, though not by way of limitation, we herein describe an illustrative embodiment of the invention with DMFC 102 which is included within a DMFC system with the fuel substance being methanol or an aqueous methanol solution. However, it is within the scope of the present invention that other carbonaceous fuels such as ethanol or combinations of carbonaceous and aqueous solutions and additives thereto may be used. Other architectures of fuel cells could also be substituted for the fuel cell 102 and fuel cell system 100 while remaining within the scope of the invention, and not simply limited to the architecture described in FIG. 1B. Those skilled in the art will recognize that the system 100 is illustrated schematically in FIG. 1B for purposes of clarity of illustration, and that this description does not include detailed descriptions of certain key components such as control components, interfaces between the fuel source 104 and fuel cell 102. As will be further recognized by those skilled in the art, such elements would be included in a fuel cell in a typical operating environment.

The system 100, which includes the DMFC 102, has a fuel delivery system for providing fuel from a fuel source 104 to the fuel cell 102 via fuel delivery conduit 105 in a manner understood by those skilled in the art. The DMFC 102 includes a housing 106 that encloses a membrane electrode assembly 110. The membrane electrode assembly (MEA) 110 incorporates a protonically conductive, electronically non-conductive membrane (PCM) 112. The PCM 112 typically includes at least one diffusion layer in contact with one or both aspects of the PCM 112. The PCM 112 has an anode aspect 114 and a cathode aspect 116, each of which may be coated with a catalyst including, but not limited to, platinum, or a blend of platinum and ruthenium.

The diffusion layers are usually fabricated from carbon cloth or carbon paper treated with a mixture of polytetrafluoroethylene and high surface area carbon particles. These are typically provided in intimate contact with the catalyzed faces of each of the anode aspect 114 and cathode aspect 116, though the invention is not limited to systems that require these types of diffusion layers.

The portion of the fuel cell 102 defined by the housing 106 and the anode aspect 114 of the membrane electrode assembly 110 is referred to herein as the anode chamber 120. The portion of the fuel cell 102 which is defined by the housing 106 and the cathode aspect 116 of the MEA 110 is referred to herein as the cathode chamber 124. The anode chamber 120 and the cathode chamber 124 may contain flow field plates or other bipolar plates which may be in contact with the diffusion layers or other components that manage mass transport of reactants and products of the reactions.

As will be understood by those skilled in the art, electricity generating reactions occur when a carbonaceous fuel mixture is delivered from fuel source 104 and introduced to the anode aspect 114 of the fuel cell. Oxygen from oxygen source 130 (which is typically ambient air) is introduced to the cathode face 116 of the MEA 110. As the fuel mixture passes through channels and any flow field plates or diffusion layers that may be present, it is ultimately presented to the anode face 114 of the PCM 112. Catalysts on the membrane surface or which are otherwise present in the MEA enable the anodic oxidation of the carbonaceous fuel, separating hydrogen protons and electrons from the fuel and water molecules of the fuel mixture. Upon the closing of a circuit, protons pass through the PCM 112, which is impermeable to the electrons. The electrons thus seek a different path to reunite with the protons and thereby travel through the load 140 of an external circuit thus providing electrical power to the load 140. So long as the reactions continue, a current is maintained through the external circuit.

Direct oxidation fuel cells produce water, carbon dioxide and heat as a result of the reactions. The carbon dioxide is vented out of the anode chamber (if desired) as illustrated by the CO₂ release arrow 144. Water generated on the cathode aspect 116 may be pushed back through the membrane 112 for use in the anodic reaction as defined in the above-cited U.S. patent application Ser. No. 10/413,983.

As noted, heat is also generated in the reaction. This heat can be useful in terms of warming the fuel cell in a cold environment and ensuring that the reactions occur at a rate that is sufficient to generate sufficient power and current to provide power to the application device. However, in other operating circumstances, the heat can build up and result in dehydration of the membrane 112, which in turn results in a loss of efficiency and lower power output of the fuel cell. Thus, the heat generated in the reaction is preferably dissipated or transferred by the heat management assembly 150 of the present invention.

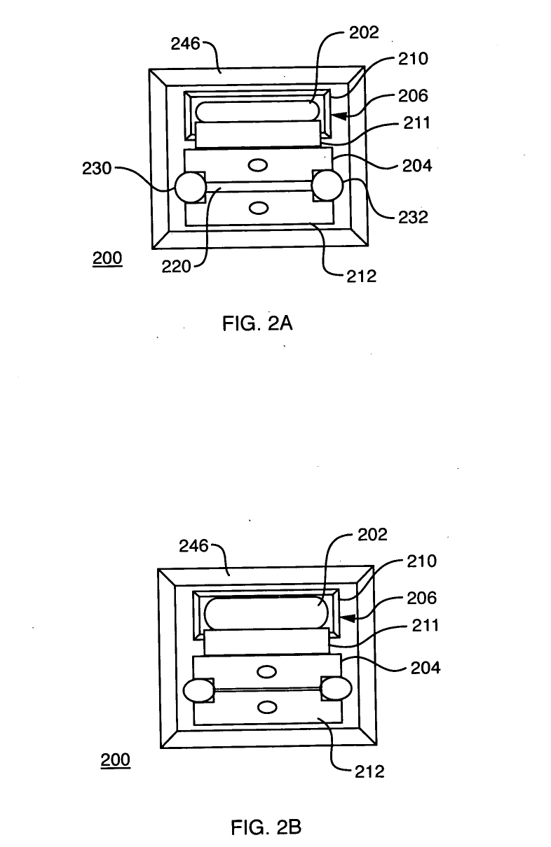

One embodiment of the integrated heat management assembly of the present invention is illustrated in FIGS. 2A and 2B. This embodiment of the invention is a heat switch 200. The heat switch 200 (as illustrated in FIG. 2A) contains an actuator material, which in an illustrative embodiment is a phase changing actuator material 202. The phase changing actuator material 202 may be paraffin or other similar material which melts and expands at a temperature as determined by its material properties. The material is selected such that its melting temperature is consistent with an upper threshold of a desired operating temperature range for the component being regulated. Thus, the material melts at that temperature and thus triggers an actuation mechanism when the threshold temperature is reached. In the device of FIG. 2A, when the material 202 reaches that threshold temperature, the melting and expansion causes movement of at least one surface of the heat switch to actuate the heat switch, to thereby transfer heat from the component to the ambient environment or to another alternative location.

As noted, materials can be selected so that the switch will close and thereby dissipate heat at a predetermined temperature. The material 202 controls the actuation. Paraffin is one exemplary material, but it is well within the scope of the invention, that any material that exhibits a physical change in response to a temperature change can be used and the heat switch adapted accordingly. Furthermore, an increase in thermal conductivity can be achieved by the addition of metal powders, such as copper, to the actuator material.

More specifically, the heat switch 200 contains a first, “hot”, surface 204 which, is thermally coupled to a component requiring temperature control . . . he hot surface 204 is in turn thermally connected to an actuator mechanism 206 which, in the illustrative embodiment, includes a base 210 and a piston 211.

A second, “cold”, surface 212 is placed at a desired distance or a gap 220 from the first surface 204, and the “cold” surface as used herein is the surface that transfers heat to the ambient environment either directly or indirectly. For example, the cold surface may be comprised of a portion of a casing or housing, or may be used to transfer heat to a casing or housing of an application device, a fuel cell system or other component. The two surfaces are separated by the gap 220 provided that the temperature has not reached a particular threshold. This gap 220 is maintained by springs formed from two O-rings 230 and 232. Alternatively, a series of elastic beads or wave springs could be used to maintain the gap opening. The gap is preferably on the order of about 250 microns, but it this will vary depending upon the particular application of the invention.

Turning to FIG. 2B, the hot surface 204 transfers heat to piston 211, which in turn transfers heat to the actuator portion 206 which in turn transfers heat to the paraffin 202. At the known threshold temperature, the paraffin melts and expands to thereby act upon the piston 211 which drives the hot surface 204 into contact with the cold surface 212, as illustrated in FIG. 2B. Thus, heat is transferred from the hot surface 204 to the cold surface 212 to thereby transfer heat from the first surface which is thermally connected to the fuel cell to the second surface which may be directed to the ambient or otherwise. When the cold surface and the hot surface reach an equilibrium such that the heat has been transferred and dissipated, the thermal conduction from the hot surface 204 via the actuator 206 to the paraffin 202 is complete, and the paraffin then retracts back to its solid phase and thereby requires less space, in which case the O-rings 230 and 232 act to push the previously hot surface 204 back to its original open position to reverse the switch to an open position.

A second thermally conductive material could be placed between the two contact surfaces to improve heat transfer and such materials may include THERMAGAP® (available from Chomerics, a Division of Parker Hannifin Corp., having a division head-quarters at 77 Dragon Court Woburn, Mass. 01888-4014). Components 202-232 are mechanically fastened to each other using a clamp 246, or otherwise held together using bolts, adhesives or other methods know to those skilled in the art. It should be understood by those skilled in the art, however, that the illustrations depict the heat switch control as occurring on the hot side. But, the actuator can be controlling the temperature on the cold side. In that instance, heat can be taken from a hot temperature source at a controlled rate to control the colder temperature component. For instance, a component can be maintained at 150° C. using heat from a 200° C. source that is signaled and controlled by a thermocouple in the 150° C. component, to deliver heat as needed to the colder temperature component.

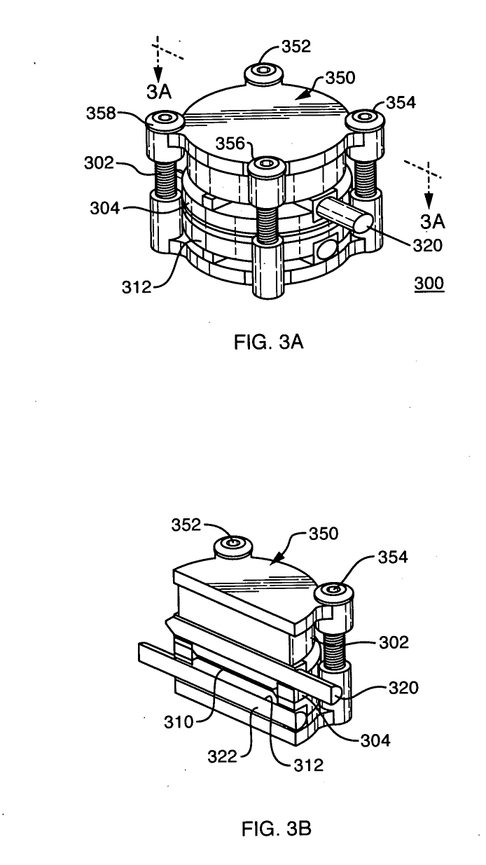

The integrated heat management assembly in the form of the heat switch of the present invention has been schematically illustrated and described with respect to FIGS. 1A through 2B. FIGS. 3A through 11B illustrate various details and implementations of several embodiments of the heat management assembly of the present invention. Those skilled in the art will recognize that the heat management assembly may be integrated with a fuel cell, or a fuel cell system, or another device such as a catalytic reactor, a system using one or more heat transfer fluids, and/or closed cabinet temperature controlled devices, and the heat management assembly will thus be correspondingly adapted in accordance with the overall design of the component being regulated and its integration with an application device.

Turning to FIG. 3A, the heat switch 300 includes an actuator material 302 which may be the phase changing paraffin material described herein. The actuator is associated with an upper hot contact 304 and a lower cold contact 312. In this embodiment of the invention, a heat pipe 320 delivers heat to the hot contact from the fuel cell system. It also delivers heat to the actuator material 302 which thereby causes the material to change shape and thus close the contacts 304 and 312.

As will be understood by those skilled in the art, a heat pipe is a heat transfer device which has an evaporator or “hot” side at which heat is taken in. The evaporator side includes a working fluid which, when heated, evaporates. The vapors of the fluid thus travel in gaseous form to the condenser (“cold”) side. Heat is thereby directed out of the condenser end of the heat pipe. The vapors condense and flow back towards the evaporator end, where the heat removal cycle began.

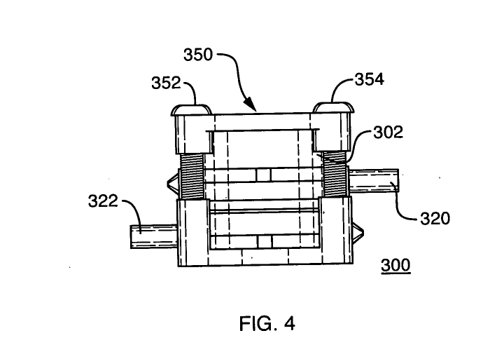

In accordance with the present invention, a second heat pipe 322 (FIG. 4) receives the transferred heat when the hot contact 304 comes in contact with the cold contact 312 when the switch is closed. The second heat pipe 322 delivers that heat to the ambient environment. In an alternative embodiment, the second heat pipe 322 delivers the heat to an application device or to perform other functionality within the fuel cell system, if desired, in a particular application of the invention. The heat switch components are clamped together with a clamp 350 and associated fastening devices 352 through 358 (FIG. 3A).

In operation, the phase change actuator 302 will act to close the air gap 310 to create a thermal conductive path from the fuel cell to the cold contact 312. Heat is then transferred to the second heat pipe 322 and thereafter to a heat sink, in order to maintain a stable cell temperature over variant ambient conditions and heat generation rates.

### EXAMPLE

A heat switch in accordance with the present invention was tested. The heat switch was tested with the air gap distance being varied between zero and 0.25 mm. The contact area of the hot contact 304 with the cold contact 312 was about 0.5 cm² per disk. The contact force varied between 0 and 5 lbs. The phase change actuator transition temperature was between about 41 degrees Celsius and 43 degrees Celsius. The interface material was Graffech Hitherm™ 0.10 PSA (16 W/mK). The conditions where tested such that the power levels varied at the lab ambient temperature of 18 to 23 degrees Celsius. The following graphs illustrate the results that were achieved by the device of the present invention.

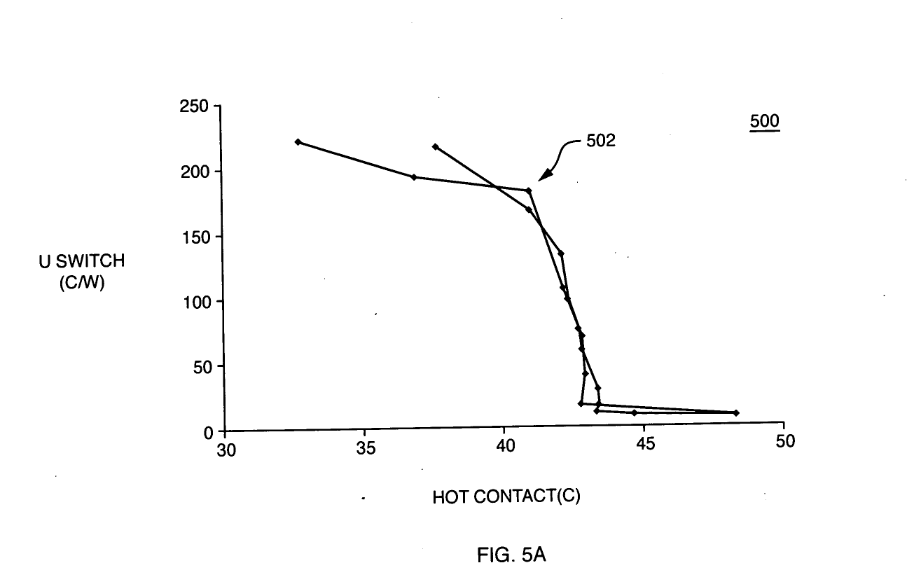

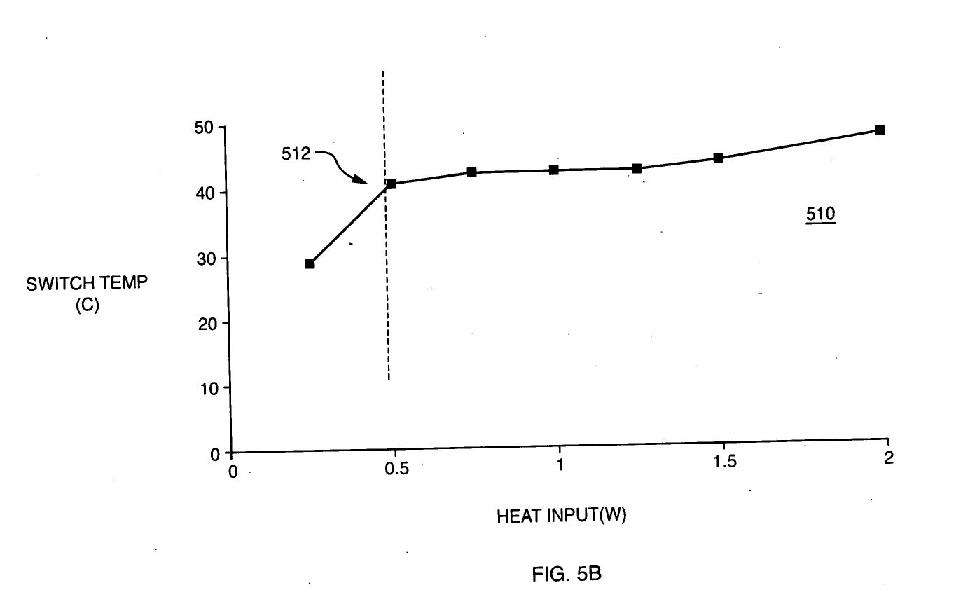

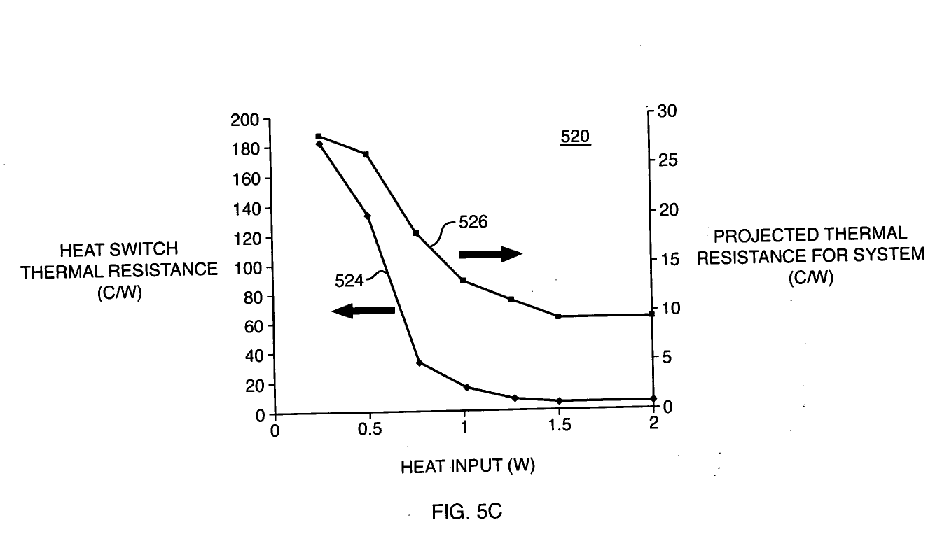

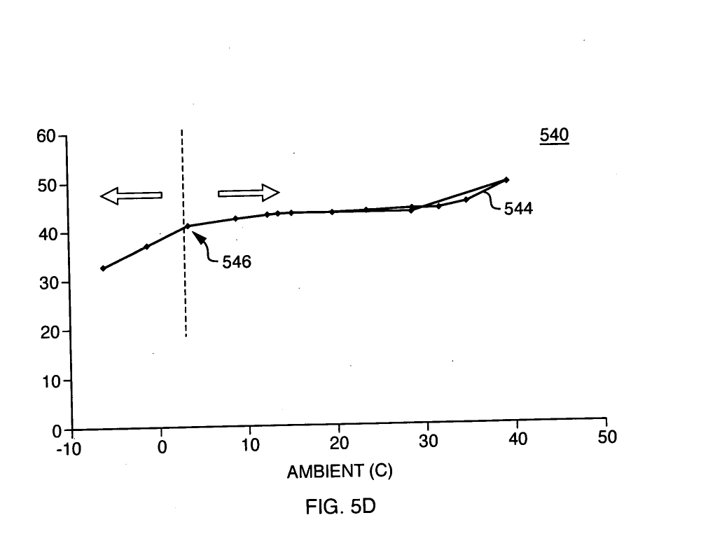

FIG. 5A illustrates the graph 500 which is a plot of heat switch thermal resistance in degrees Celsius per watt (C/W) vs. the temperature of the hot contact in degrees Celsius (C). It can be seen that the hot contact governs the change in resistance of the heat switch, and there is little or no delay shown so that as the hot contact becomes hotter, the heat switch closes at about point 502 to divert heat from the hot contact to lower the thermal resistance of the heat switch, and maintain temperature at a set point.

FIG. 5B illustrates the graph 510 which shows actuator temperature in Celsius plotted against heat input in watts and this illustrates that when the phase changing material melting point of 42 Celsius, is reached at 512, then the switch actuation temperature is reached. As shown in the graph 510 when the switch is opened, the temperature increases, however, when the switch is closed, (at 512) the switch temperature is maintained over a range of heat input in Watts. The phase change material melting point can be easily tuned to the desired operating temperature by selecting a different material or by placing additives in the selected material to adjust for desired operating temperatures of the fuel cell in accordance with the present invention.

FIG. 5C is a graph 520 of thermal resistance of the heat switch (in C/W) plotted against heat input (W). This graph 520 illustrates curve 524 that is based on the thermal resistance of the switch as compared with the projected thermal resistance 525 for the overall system. Both curves show a decrease in thermal resistance as the heat switch diverts heat out of the system.

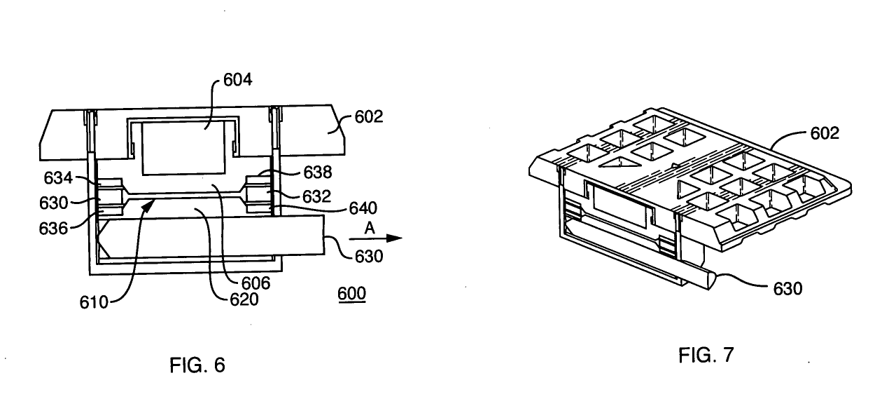

The advantages of the heat switch of the present invention can be particularly appreciated with reference to the graph 540 of FIG. 5D, which shows actuator temperature (C) vs. the ambient temperature (C). The curve 544 illustrates an increase in temperature when the switch is opened; however, when the switch is closed (546) the temperature is substantially maintained constant for a range of ambient temperatures. In other words, the heat switch controls the temperature (as shown by the actuator temperature) over a range of ambient conditions and heat inputs. Another embodiment of the invention is illustrated in FIGS. 6 through 8. In the embodiment of FIG. 6, the heat switch 600 is coupled to a heat bridge 602 which is either coupled to or is physically a portion of the fuel cell. In accordance with one embodiment of the invention, the heat bridge is comprised of a portion of one of the current collectors of the fuel cell. As shown in FIG. 6, the actuator 604 is a material that expands when heated and thus acts upon an actuator plunge or “hot contact” 606. The hot contact 606 is separated by an air gap 610 from the cold contact 620. The air gap 610 is maintained by wave springs 630 and 632. The wave spring 630 is held in place by plastic shims 634 and 636. Similarly, the wave spring 632 is held in place by plastic shims 638 and 640. A heat pipe 630 is thermally coupled to the cold contact 620. The heat pipe 630 transfers heat, which is thermally conducted from the fuel cell via the heat bridge 602, through the hot contact 604 when it is moved by the actuator 604 to close the air gap 610 and come in contact with the cold contact 620. Heat is thereby transferred from the hot contact 606 to the cold contact 620 and to the heat pipe 630. The evaporator portion of the heat pipe 630 is at the end of the pipe 630 which is within the heat switch housing 640. As will be understood by those skilled in the art, the heat at the evaporator end of the heat pipe heats up a liquid (not shown) which evaporates and emits heat from the opposite end illustrated by the arrow A, to illustrate that the heat is delivered to the ambient environment by the heat pipe 630.

Another perspective view of this embodiment of the invention is illustrated in FIG. 7 in which the heat bridge 602 and the heat pipe 630 leading to the ambient environment are both visible.

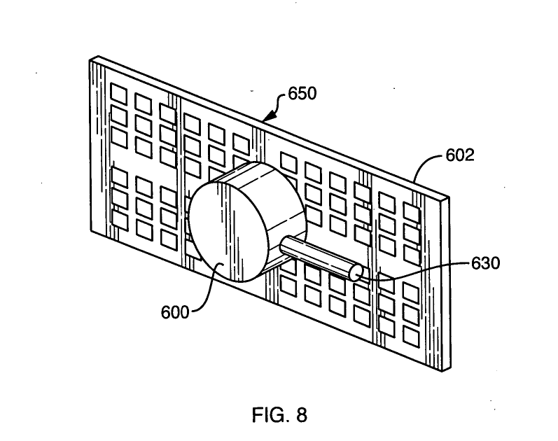

FIG. 8 illustrates an isometric side elevation which shows the heat bridge 602 and the compact heat switch 600 which includes the heat pipe 630 for thermally conducting heat from the fuel cell to the ambient to thereby control the temperature of the fuel cell. In accordance with one aspect of the invention, bridge 602 may actually be one of the current collectors, i.e. on the anode side or the cathode side of the fuel cell. This embodiment of the invention relies on the lateral conductivity of the current collector of each cell. Heat can be drawn to the center area 650 of the current collector 602, in a biaxially symmetrical fuel cell array. When the temperature of a fuel cell rises to above a set temperature, the switch 600 closes, and then heat is delivered via the heat pipe 630, to the ambient environment or other heat sink. It is noted that a single heat switch can transfer heat from multiple sources. For example, the switch 600 transfers heat from the four cells in the four fuel cell array 630 as shown in FIG. 8.

The desired temperature range for actuation will depend upon the component being controlled by thermal conductance. The heat switch of the present invention is a variable conductance device that upon passive or active actuation can be adapted to drastically increase or decrease heat transfer.

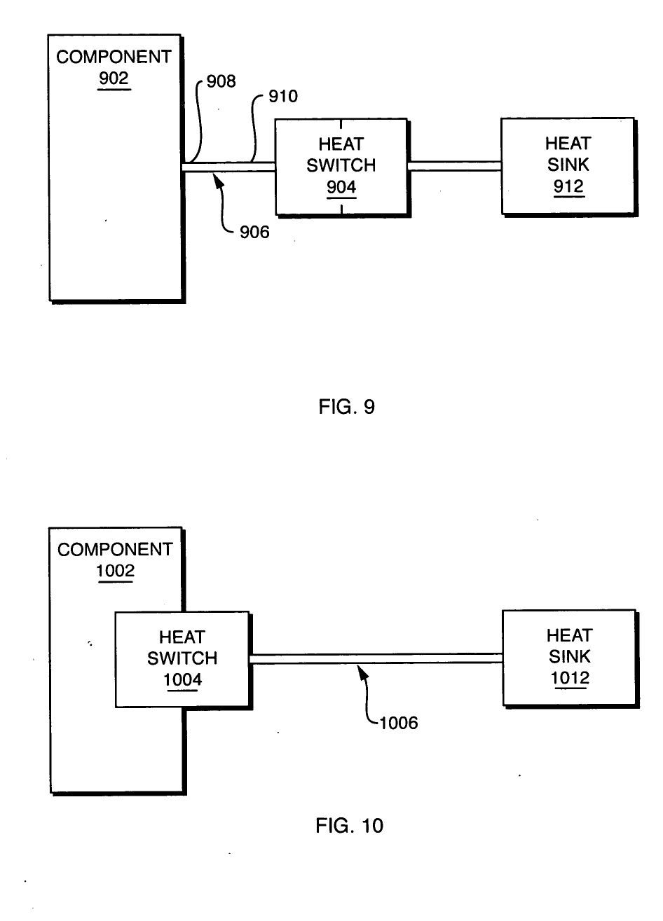

In accordance with further aspects of the invention, it is noted that the heat switch and the heat pipe do not necessarily have to be integrated within the component requiring temperature control, and can be separately implemented. For example, as shown in FIG. 9, the component 902 is coupled to a heat switch 904 which is disposed external to the component. The component 902 is connected to the heat switch 904 by a heat pipe 906. The evaporator side 908 of the heat pipe 910 will draw heat from the component 902 and will deliver it to the condenser side 910 of the heat pipe 906. The condenser side is coupled to the heat switch 904. The heat switch 904 can be any of the embodiments described herein, in which a material actuator changes position when heated to close the two opposing surfaces (e.g. FIG. 2B) the heat switch 904 then delivers the heat to an appropriate heat sink 912. The heat sink 912 can be explicitly designed with fins, or a fan as necessary to dissipate the heat. In certain implementations of the invention, the heat sink 912 is an available surface of an application device such as a hand held device, for example, to which the component 902 is integrated.

An alternative to the embodiment illustrated in FIG. 9 is shown in FIG. 10. In this case, the component 1002 has an integrated heat switch 1004 within the component itself. The integrated heat switch 1004 is coupled via a heat pipe 1006, to a heat sink 1012. This embodiment may provide additional control in that the heat switch 1004 can be intentionally actuated, (opened or closed) to control whether heat is dissipated out of the component. In the fuel cell embodiment, this may be desirable under certain circumstances, such as flooding and/or drying out conditions. An advantage to the heat switch being contained within a fuel cell instead of outside of the fuel cell is that the component itself may provide additional compression within the fuel cell which enhances fuel cell performance.

Those skilled in the art will understand that it is possible to provide alternative architectures such as integrating the heat switch and the heat sink.

The component of FIGS. 9 and 10, as well as the component requiring temperature control in any of the embodiments described herein, may be one of a number of different devices, such as a fuel cell or fuel cell system, or a catalytic reactor. In the catalytic reactor application, it will be understood by those skilled in the art that adding and removing heat to and from a catalytic reactor is difficult. It is also difficult to limit the temperature variation that occurs within the catalyst reactor itself. Wall effects as well as flow distribution differences create temperature variations in different parts of a catalytic reactor, as will be understood by those skilled in the art.

The performance and emissions of a reactor are often negatively affected by these temperature variations. Being able to reduce such temperature variations, as well as to add or to remove heat from the reactor evenly to control temperature can be accomplished using the heat switch of the present invention. Furthermore, heat taken from the reactor using the heat switch of the present invention can be utilized elsewhere in some systems to increase overall efficiency. Heat can also be added to some reactors using the heat switch during start-up to increase temperature and reduce cold-start emissions. The reactors described are not limited to any one application.

As described above, reactor temperature control presents difficulties in two areas; temperature variability across the reactor due to variations in flow and end effects; and, mean temperature control due to variations in the amount of heat being released. The heat switch device of the present invention used with heat pipes can help alleviate both of those problems at the same time. For instance, heat pipes can be imbedded within catalytic converters (for instance perpendicular to flow) with an end of them extending outside of the catalyst bed and attached to a heat switch. In this application the heat pipes are serving at least two purposes: 1. they are providing heat uniformity within the catalyst bed; and 2. allowing heat to be taken out of the catalyst evenly. Likewise, during start-up of various processes the heat pipes and heat switches can be used to direct heat into the catalyst bed. In prior designs, typically, there are heat exchangers put between catalyst beds to help remove or add heat. The addition of these heat pipes and heat switches in accordance with the invention, within the reactor design, allow heat to be removed or added in the same device.

It should be noted that one or more heat pipes could come into one end (i.e., the hot contact or the cold contact) of the heat switch to interface with one or more heat pipes on the other contact. The heat switches and heat pipes do not have to align one-for-one. For instance, one large heat pipe can sink heat effectively into a fluid where it may take an array of heat pipes to pull heat evenly from a catalysis bed. Thus, it should be noted by those skilled in the art that there are a number of variations on the architecture of the heat management assembly of the present invention in that the number of heat pipes and heat switches, and the connections there between, can be arranged in a variety of configurations while remaining within the scope of the present invention.

In accordance with the method of the present invention, one way of determining whether to actuate the switch includes selecting a set temperature, Tset, at which good cell performance can be obtained over a wide range of ambient temperatures, but above which, component performance begins to deteriorate. The heat switch 904 or 1004 could include a material that changes shape or other characteristic at Tset. Alternatively, a second actuator can be signaled by an associated microcontroller to trigger the heat switch to close at Tset, which may be employed in circumstances in which it is desired to shed heat more quickly, or at when Tcompenent is less that Tset. If Tcomponent is greater than Tset, then the thermal switch will contact or otherwise become coupled to the heat sink 912, 1012 to divert heat away from the component.

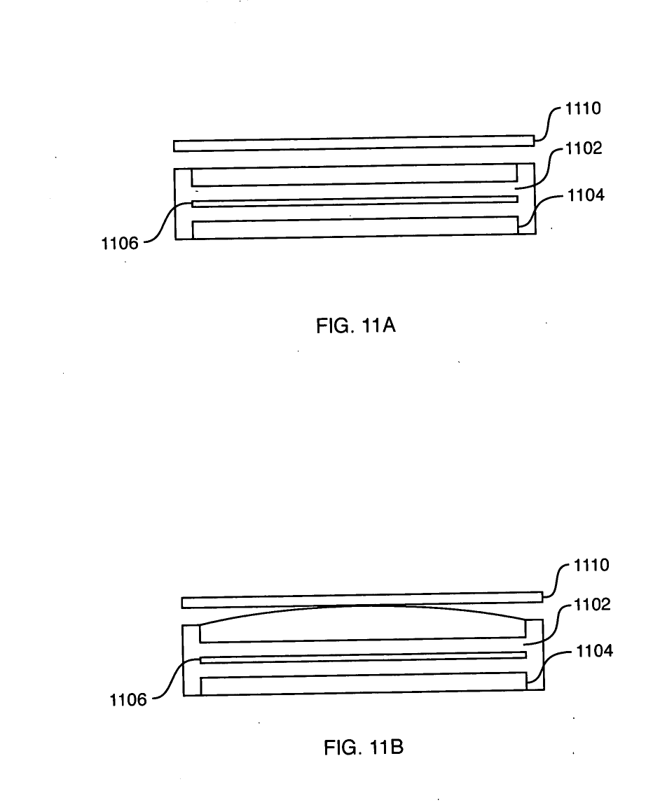

In accordance with yet a further embodiment of the invention as used with a fuel cell, one or both of the anode and cathode current collectors of the fuel cell can be formed of such a material that they expand or contract with temperature. As illustrated in FIGS. 11A and 11B, current collector 1102 and current collector 1104 sandwich the MEA 1106. Current collector 1102 is comprised of a material that deforms at a predetermined temperature. In FIG. 10A, current collector 1102 is depicted in an undeformed state. This would occur, for example, when the fuel cell is functioning at a desirable operating temperature. Should the fuel cell operating temperature reach a preset threshold, which is selected to be the temperature at which the material of the current collector 1102 expands, an associated plate 1110 is pushed in a predetermined direction which in turn closes an associated heat switch in accordance with the invention as described herein. In this manner, the current collectors are used instead of a separate phase change actuator to open and close the heat switch.

Here would be a good place for description of a 4 cell array to heat switch to case embodiment

In accordance with the method of the present invention, the thermal management can be used for controlling hydration in the fuel cell, i.e. to control a flooding condition or a drying out of the fuel cell. More specifically, there are measurements which can distinguish between these two performance loss scenarios. Flooding indicators include a drop in cell current followed by a drop of measured open circuit voltage and a drop of cell resistance. In contrast, fuel cell dry out indicators include a drop in cell current followed by a rise in cell resistance with little effect on measured open circuit voltage. From this, it can be determined whether to control the temperature of the fuel cell to thereby encourage water accumulation (referred to as flooding) to avoid drying out, or to intentionally dry the fuel cell to decrease an over hydration condition. The steps may be performed in a sequence other than as shown in the flow chart and there may be additional procedures performed while remaining within the scope of the present invention.

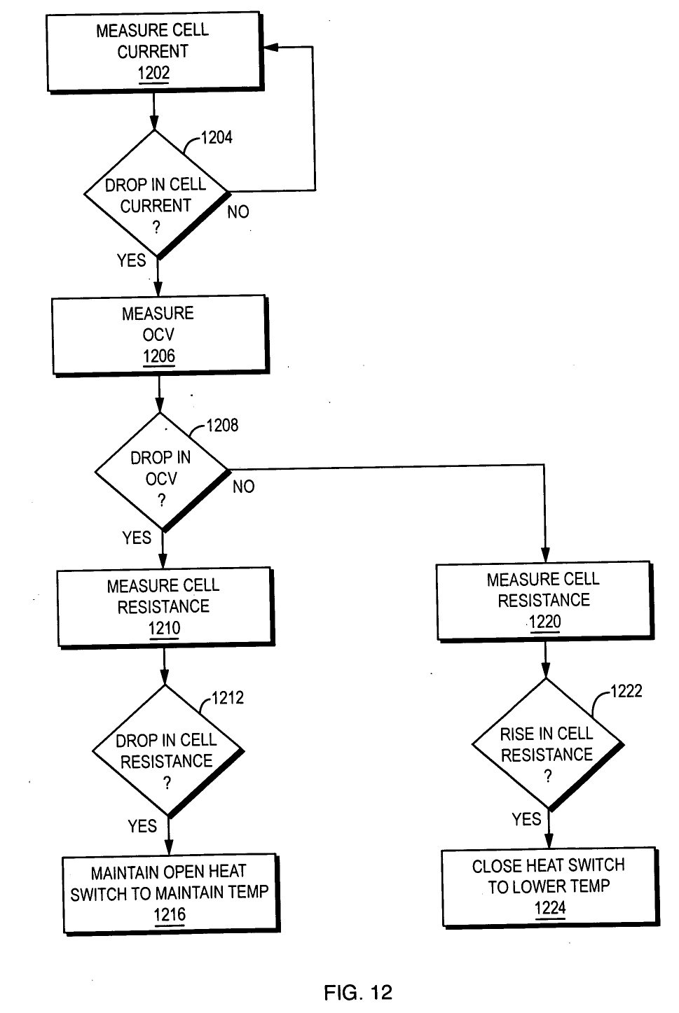

The flow chart of FIG. 12 illustrates how, in accordance with the present invention, the heat switch can be used to control the temperature in order to promote dry out or to promote hydration. FIG. 12 illustrates the procedure 1200 in which the first step 1202 is to measure cell current. The cell current is measured to determine whether there is a drop in cell current, as shown in decision step 1204. If there is no drop in the cell current the path loops back to continue measurement. If there is a drop in cell current, the next step is to measure open circuit voltage as illustrated in step 1206. This measurement is followed by a decision step (1208) which determines whether there is a drop in open circuit voltage. If there is such a drop, then cell resistance is measured, as shown in step 1210. As shown in the decision step 1212, if there is a drop in cell resistance then this is an indicator that there is a flooding condition in which case it would be desirable to increase temperature to increase thermal resistance to thereby dry out the cell. Thus, the heat switch of the present invention would thus remain open in order to retain the heat within the fuel cell (1216). Referring back to decision step 1208, if little or no drop in open circuit voltage is detected, then the procedures would continue to step 1220 in which fuel cell resistance is measured. If there is a rise in cell resistance as shown in the “yes” path from decision step 1222, then this would suggest that there is a dry out condition occurring in the fuel cell system, in which case the temperature would need to be lowered in order to promote hydration. In such a case, step 1224 indicates that the heat switch should be closed in order to lower the temperature of the fuel cell system.

As will be understood by those skilled in the art, an actuator can be excited in many ways. For example, the paraffin actuator described herein can be actuated intrinsically by the heat generated from the component. The actuator can also be excited extrinsically through electrical power directed to a heater embedded in the paraffin. This function requires some power, however, in certain circumstances it may be advantageous to cause actuation of the heat switch based on factors other than the temperature of the heat switch. For, example, even in cold environments, the circuits of the portable electronics device including, but not limited to, the central processing unit, radio frequency transmitters, or memory devices, will generate heat. The heat generated by these devices can be routed to the component to help raise the temperature of the cell operating in such a cold environment until the component can sustain the desired component operating temperature through self heating.

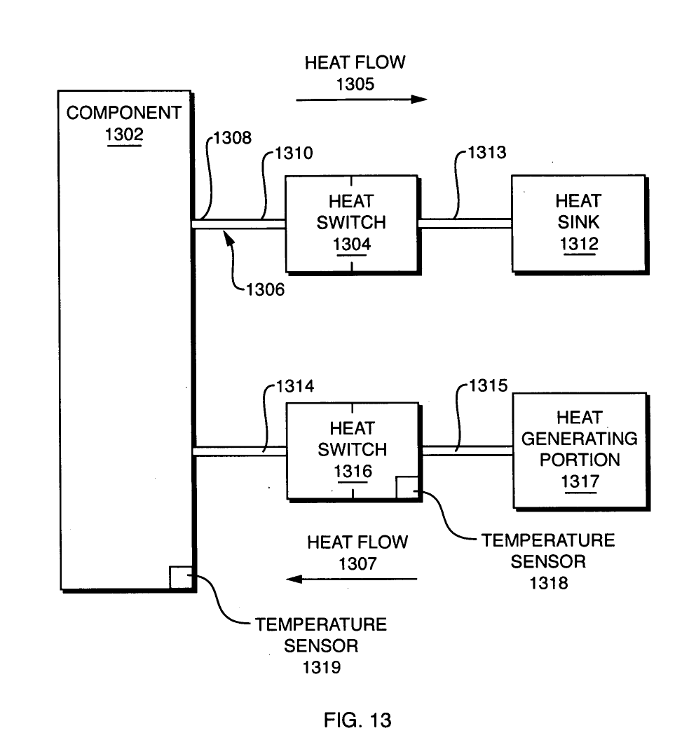

In accordance with this aspect of the invention, FIG. 13 shows a component 1302 that is connected through a heat pipe 1306 to a heat switch 1304. The heat switch 1304 is connected to a heat sink or device case 1312 such that the heat from the component can flow in the path designated with reference character 1305 from the component to the heat sink. An additional heat path 1307 is designed that includes the heat generating portion of the electronics device 1317—such as the central processing unit, the radio frequency transmitter, or the memory—the heat pipe 1315, another extrinsically activated heat switch 1316, and heat pipe 1314 which is connected to the component. Temperature sensors 1319 and 1318 are used to control the flow of heat such that heat flows only to the component. In cases were the electronics is already at a high temperature, and the component is producing heat, it will be understood by those skilled in the art that it is typically undesirable to direct waste heat to the electronics. Therefore, the temperature sensors are used to assure that the temperature indicated by sensor 1319 is maintained at a lower value than the temperature indicated by sensor 1318, while the heat switch is actuated and the heat conduction path 1307 is enabled.

It should be understood that the method and apparatus of the present invention provides a heat management assembly for use with many different components requiring temperature management which is compact, low power and highly efficient for controlling the temperature within the fuel cell which can in turn control the hydration of the fuel cell. This control results in a higher efficiency, higher output fuel cell system. It is expressly contemplated that the heat management of the present invention, while described in conjunction with a fuel cell.

The foregoing description has been limited to a specific embodiment of the invention. It will be apparent, however, that variations and modifications may be made to the invention with the attainment of some or all of its advantages. Therefore, it is the object of the appended claims to cover all such variations and modifications as come within the true spirit and scope of the invention.

What is claimed is:

1. A heat switch for use with a component requiring temperature control, the heat switch comprising:
(A) a first contact having a first surface, said first contact being thermally coupled to at least a portion of an associated component requiring temperature control;
(B) a second contact having a second surface disposed and spaced apart by a gap between itself and said first contact; and
(C) a thermally responsive material thermally coupled to said component requiring temperature control such that upon said component requiring temperature control reaching a predetermined temperature, said thermally responsive material acts to close said gap to bring at least a portion of said first and second surfaces together such that heat is conducted from said first surface to said second surface.

2. The heat switch as defined in claim 1 further comprising one or more spring action devices disposed to retain said gap between said first surface and said second surface when said thermally responsive material is in a non-actuated state.

3. The heat switch as defined in claim 1 wherein said thermally responsive material acts to close said gap when a temperature increase causes a change in a physical property of said thermally responsive material.

4. The heat switch as defined in claim 1 wherein said second surface is at a higher temperature than said first surface such that heat is transferred to said first surface upon actuation of said heat switch.

5. The heat switch as defined in claim 1 wherein said first surface is at a higher temperature than said second surface such that heat is transferred to said second surface upon actuation of said heat switch.

6. The heat switch as defined in claim 1 further comprising one or more heat pipes coupled between the first surface and said component requiring temperature control, and/or one or more heat pipes coupled between said second surface and a heat source or a heat sink.

7. The heat switch as defined in claim 1 wherein said second contact is coupled to the ambient environment or an associated heat sink such that when heat is conducted from said first surface to said second surface, heat is thereafter conducted to the ambient environment or to an associated heat sink.

8. The heat switch as defined in claim 1 wherein said component requiring temperature control is a fuel cell.

9. The heat switch as defined in claim 1 wherein said component requiring temperature control is a fuel cell system.

10. The heat switch as defined in claim 1 wherein said component requiring temperature control is a catalytic reactor.

11. The heat switch as defined in claim 1 wherein said component requiring temperature control is a heat transfer fluid system.

12. The heat switch as defined in claim 1 wherein said component requiring temperature control is a closed cabinet having an internal environment requiring a substantially constant temperature.

13. A direct oxidation fuel cell comprising:
(A) a membrane electrode assembly including
(i) a protonically conductive, electronically non-conductive membrane electrolyte, having an anode aspect and an opposing cathode aspect; and
(ii) a catalyst coating disposed on at least one of said anode aspect and said cathode aspect, whereby electricity generating reactions occur upon introduction of fuel solution from an associated fuel source including an anodic conversion of said fuel solution to carbon dioxide, protons, electrons and heat and a cathodic combination of protons, electrons and oxygen from an associated source of oxygen, producing water;
(B) a heat switch thermally coupled to at least a portion of said membrane electrode assembly said heat switch comprising:
a first contact having a first surface, said first contact being thermally coupled to at least a portion of said membrane electrode assembly;
a second contact having a second surface and spaced apart from said first surface by a gap;
a thermally responsive material, thermally coupled to said membrane electrode assembly such that upon said membrane electrode assembly reaching a predetermined temperature, said thermally responsive material closes said gap to bring at least a portion of said first and second surfaces together such that heat is conducted from said first surface to said second surface and ultimately to a heat sink to divert heat away from said fuel cell and to lower the temperature of said fuel cell.

14. The direct oxidation fuel cell as defined in claim 13 wherein said thermally responsive material undergoes a physical change upon a temperature increase such as to close said gap.

15. A direct oxidation fuel cell system comprising:
a direct oxidation fuel cell having a membrane electrode assembly including a protonically conductive electronically non-conductive membrane having an anode aspect and a cathode aspect;
a fuel source coupled to deliver fuel to said anode aspect;
an oxygen source coupled to deliver oxygen to said cathode aspect; and
a heat switch coupled to at least a portion of said fuel cell to divert heat away from said fuel cell under predetermined circumstances.

16. A method of controlling temperature in a component including the steps of providing a heat switch coupled to said component in such a manner that when said component reaches a predetermined temperature, the heat switch is activated to divert heat away from said component.

17. A method of controlling temperature in a component including the steps of providing a heat switch coupled to said component such that said heat switch is activated to divert heat away from said component or to add heat to said component to maintain said component in a desired operating temperature range.

18. A method of controlling temperature in a fuel cell system including the steps of providing a heat switch coupled to said fuel cell system in such a manner that when said fuel cell reaches a predetermined temperature, the heat switch is activated to divert heat away from said fuel cell system.

19. A method of controlling hydration in a fuel cell system, including the steps of:
(A) determining the hydration state of the fuel cell system;
(B) if the hydration state is too low, then closing a heat switch associated with the system to divert heat away from the fuel cell system; and
(C) if the hydration state is too high, then opening the heat switch to maintain heat within the fuel cell system in order to raise the temperature of the fuel cell system.

20. The method of controlling hydration in a fuel cell as defined in claim 19 including the further steps of:
providing said heat switch coupled to at least a portion of said fuel cell;
measuring cell current;
comparing said measured cell current with previous values of said cell current to determine whether there is a drop in cell current;
if a drop in cell current is detected, measuring open circuit voltage;
if a drop in open circuit voltage is detected, measuring cell resistance;
if there is a drop in cell resistance then maintaining the heat switch open to maintain temperature;
alternatively, if there is a rise in cell resistance, closing said heat switch to lower the temperature of the fuel cell system.

21. A heat management system for use with a direct oxidation fuel cell system that is powering a portable electronic device, comprising:
(A) a direct oxidation fuel cell having a membrane electrode assembly including a protonically conductive electronically non-conductive membrane having an anode aspect and a cathode aspect, said fuel cell also having a temperature sensor associated with the fuel cell;
(B) a first heat switch coupled to at least a portion of said fuel cell to divert heat away from said fuel cell under predetermined circumstances; and
(C) a second heat switch coupled between a heat generating portion of said portable electronic device and said fuel cell, and said heat switch being capable of extrinsic actuation to create a heat path from said heat generating portion of said portable electronic device to said fuel cell to raise the operating temperature of said fuel cell in desired circumstances.

22. The heat management system as defined in claim 21 further comprising one or more heat pipes coupled between said first heat switch and said fuel cell, and said second heat switch and said fuel cell; and said second heat switch and said heat generating portion of said electronic device.

23. A heat switch for use with a direct oxidation fuel cell, comprising:
(A) a first contact component having a first surface, said first contact component being thermally coupled to at least a portion of an associated fuel cell;
(B) a second contact component disposed and spaced apart by a gap between itself and said first component; and
(C) a thermally responsive material thermally coupled to said fuel cell such that upon said fuel cell reaching a predetermined temperature, said thermally responsive material acts to close said gap to bring at least a portion of said first and second surfaces together such that heat is conducted from said first surface to said second surface.

24. The heat switch as defined in claim 23 further comprising one or more spring action devices disposed to retain said gap between said first surface and said second surface when said thermally responsive material is in a non-actuated state.

25. The heat switch as defined in claim 23 wherein said thermally responsive material acts to close said gap when a temperature increase causes a change in a physical property of said thermally-actuated material.

26. The heat switch as defined in claim 23 wherein said second component is coupled to the ambient environment or an associated heat sink such that when heat is conducted from said first surface to said second surface, heat is thereafter conducted to the ambient environment or to an associated heat sink.
